(19) United States
(12) Patent Application Publication
(10) Pub. No.: US 2026/0192502 A1
(43) Pub. Date: Jul. 9, 2026

(54) EXTRUSION TEMPLATE AND METHOD

(71) Applicant: Continental Reifen Deutschland GmbH, Hannover (DE)

(72) Inventors: Norbert Kendziorra, Garbsen (DE); Christian Kunze, Hannover (DE); Sven Kastens, Barsinghausen (DE)

(73) Assignee: Continental Reifen Deutschland GmbH, Hannover (DE)

(21) Appl. No.: 19/133,247

(22) PCT Filed: Nov. 22, 2023
(86) PCT No.: PCT/DE2023/200231

§ 371 Date: May 28, 2025

(30) Foreign Application Priority Data
Dec. 5, 2022 (DE) 10 2022 213 083.9

(51) Int. Cl. B29C 48/20; B29C 48/07; B29C 48/30; B29C 48/92; B29K 9/00; B29L 30/00

(52) U.S. Cl. CPC B29C 48/20; B29C 48/07; B29C 48/304; B29C 48/92; B29C 2948/92628; B29C 2948/92942; B29K 2009/00; B29L 2030/002

(57) ABSTRACT

The invention relates to an extrusion template for use in the extrusion of rubber products, comprising: a) a template body, b) a template cutout, which penetrates the template body along an extrusion direction E and which is delimited by encircling wall surfaces, and c) an elongate injector element, which extends between the wall surfaces along the injector direction I through the template cutout, with an injection gap, wherein the extrusion template is designed to produce a material gap in a material strand extruded through the template cutouts along the extrusion direction E by means of the injector element and to inject an injection composition into the material gap through the injection gap in order to bring the extruded material strand into contact with the injection composition at the walls, wherein the extrusion template comprises at least one distribution hollow, which is wider than the injection gap along the transverse direction Q, and wherein the extrusion template is designed such that an injection composition which is injected into the material gap can enter the distribution hollow, with the result that the extruded material strand which is guided via the distribution hollow can be brought into contact, on the outer side, with the injection composition.

### CROSS-REFERENCE TO RELATED APPLICATION

This application is a National Stage Application under 35 U.S.C. § 371 of International Patent Application No. PCT/DE2023/200231 filed on Nov. 22, 2023, and claims priority from German Patent Application No. 10 2022 213 083.9 filed on Dec. 5, 2022, the disclosures of which are herein incorporated by reference in their entireties.

### BRIEF SUMMARY

The invention relates to an extrusion template for use in the extrusion of rubber products, to an extrusion system comprising this extrusion template, to a method for producing a strand-shaped vulcanizable rubber product that can be carried out by means of extrusion, to a method for producing a vulcanized rubber product on the basis thereof, and to a vulcanized rubber product produced by this method.

A significant component of modern pneumatic vehicle tires, which in many cases is decisive for the performance characteristics of these products, is the tread. Nowadays, treads generally consist of a number of different components, in particular various rubber materials, which can be obtained by vulcanization from vulcanizable rubber compounds. Corresponding treads are generally produced by what is referred to as coextrusion of various vulcanizable rubber compounds and usually, in respect of their construction, can expediently be described by way of their cross section, which, apart from any effects of the profiling, is usually uniform through the entire tread strand.

In the cross-sectional view, most treads, especially in the passenger car and truck sectors, comprise one or more rubber materials, which are intended to have contact with the road in subsequent use and are optimized for this purpose in terms of their properties. Here, this layer, which acts as it were as a top layer, is produced from a vulcanizable rubber compound, which is sometimes also referred to as a “cap compound”, which often comprises large proportions of fillers that are not electrically conductive, e.g. precipitated silica.

Below the rubber material provided for road contact there is generally a base ply (often also referred to as a “base”). In the vast majority of cases, this base ply serves especially to produce sufficient adhesion between the top layer provided for road contact and the other parts of the pneumatic vehicle tire, thus making it possible to ensure high strength of the bond between the tread and the other component parts of the pneumatic vehicle tire.

Those skilled in the art know that, for the majority of applications, a tread must have a certain overall electrical conductivity, which can prevent unwanted static charging. In many cases, however, the rubber material of the top layer does not have adequate electrical conductivity to ensure this.

In the prior art, therefore, the electrical conductivity of the overall tread is generally achieved by means of the base compound of the underlying base ply, which has a raised electrical conductivity, in particular as a result of a high carbon black content. For this purpose, a material strand is, for example, passed out of the base ply as far as the upper side of the tread, thereby establishing an electrically conductive connection between the surface of the tread and the base ply. In this case, the electrically conductive base compound is usually formed as far as the surface of the tread by a preliminary template in the extruder. Here, the corresponding structure is also referred to as a “carbon center beam” (CCB). Information on the technological background is disclosed, for example, in DE 4445758 B4, DE 69717958 T2, EP 1792720 A2, NL 2006420 C2 and US2018170123 A1.

In many cases, however, the formation of a CCB from the vulcanizable rubber compound of the underlying base ply is felt to be disadvantageous in terms of production engineering, e.g. in respect of the number of extruder heads required, the often complex flow management in the extruder head, and the requirement for material. Moreover, the “base” compound is generally not intended for road contact, and therefore the resulting partial coverage of the tread surface with “base” compound is sometimes also felt to be disadvantageous in respect of the driving characteristics. In addition, some treads are entirely lacking a suitable “base” compound with which a CCB could be implemented, and therefore the connection of the lower side of the tread with the surface has to be formed by means of an additional extruder.

Against this background, in this field of technology there is a need to provide tread constructions which have a sufficient electrical conductivity, but which exhibit the smallest possible influence of the CCB on the driving characteristics.

For this purpose, devices and methods have been developed by means of which it is possible, during the production of the treads, to produce a particularly thin conductive region which, in the subsequent vehicle tire, extends in a radial direction through the tread and which is advantageously sufficient to reliably prevent static charging. These new concepts are based on the fact that, during the formation of the vulcanizable rubber compounds, an electrically conductive rubber compound is introduced into the tread by applying said compound in a thin layer thickness to the lateral surface of the extruded strands. To form the lateral surface to be coated, the extruded tread can be cut through in its longitudinal direction, for example, as disclosed in DE 102007039100 A1, or only part of a tread is directly extruded and, after appropriate coating, is combined with other parts to give the tread, as disclosed in DE 102007039101 A1, for example. Further disclosures relating to this approach can be found in EP 2520421 B1 and EP 3253553 B1, for example. Depending on the requirements of the respective technology employed, it is possible here to make direct use of electrically conductive rubber compounds as electrically conductive materials for the coating, or of suitable precursors of such a conductive rubber compound, as an injection composition, in particular solutions or dispersions in solvents capable of being evaporated, thus allowing coating from an advantageously flowable solution.

The inventors have recognized that, in principle, there is a preference for embodiments in which this method is used to form a very thin conductive web, that is to say if-depending on the viscosity of the conductive rubber compound used-a thickness of less than 20 μm is established, for example. Not only does this minimize the effect of the web on the driving characteristics but, in particular, reliable joining of the tread parts that were separate before coating is also possible, something that, in the estimation of the inventors, is not always adequately guaranteed in the case of significantly thicker webs. At the same time, the inventors have recognized that corresponding thicknesses are sufficient to dissipate the static electricity.

If a corresponding thin web is used, however, the contact area on the lower and the upper side of the tread becomes very small since the corresponding CCB has only a very small cross-sectional area. Here, the reduction is so pronounced in the case of preferred thin webs as compared with conventional CCBs that there is the risk that the inherently desirable reduction in the surface area occupied by the conductive material goes too far and that reliable contacting of the underlying surface can no longer be adequately guaranteed in all situations. This problem is intensified even further by the fact that, for production reasons, there is the risk that the rubber elements flanking the thin CCB will be deformed at the boundary surface to such an extent during further processing, e.g. in the course of a vulcanization process carried out under pressure, that the interposed thin CCB will be covered by the flanking rubber elements or that these flanking rubber elements will form between them a hollow into which the CCB is sunk and, as a consequence, will not reach as far as the surface of the tire. In these cases, a CCB that is actually suitable cannot perform the task it is intended to perform on a new tire because an adequate conductive path to the road surface is not formed.

The primary object of the present invention was to eliminate or at least mitigate the disadvantages of the prior art.

In particular, it was an object of the present invention to specify a method for producing a strand-shaped vulcanizable rubber product, in particular a tread, and devices and systems designed for this method, by means of which it is possible to introduce into the strand-shaped vulcanizable rubber product particularly thin webs of conductive material which, despite the small cross-sectional area, should ensure reliable accessibility and easy electrical contact making between the web and the upper and/or lower side of the strand-shaped vulcanizable rubber product.

It was a further object of the present invention that it should be possible to use the method, devices and systems to be specified to produce advantageous vulcanizable or vulcanized rubber products, in particular treads which have a very thin CCB and, as a result, have excellent rolling characteristics. Thus, it was an object of the present invention that, despite the thin CCB, the vulcanizable or vulcanized rubber products should allow reliable dissipation of electrical charges, wherein, in the case of treads, reliable contacting of the road and/or of underlying tire components should be ensured, in particular, especially in the case of new tires, the tread surface of which has not yet been altered by abrasion.

Moreover, it was an object of the present invention that the method to be specified should require reduced outlay on machinery and/or have a lower requirement for materials in comparison with the prior art.

Furthermore, it was a supplementary object of the present invention that it should be possible to carry out the method to be specified in a manner that is as efficient as possible in terms of time and costs.

It was a further object of the present invention to provide advantageous vulcanized rubber products which can be produced by the methods, devices and systems to be specified.

The inventors of the present invention have now found that the objects described above can be achieved if, in contrast with the methods known from the prior art, not only is an injection composition used to produce a thin, electrically conductive modification layer in the strand-shaped vulcanizable rubber product but also a superficial coating with the conductive material is furthermore provided on at least one side, something that can take place during extrusion by means of specific distribution hollows in the extrusion template, as defined in the claims. A thin, electrically conductive surface layer, which is reliably connected to the thin CCB and ensures a large contact area is obtained locally in an advantageous manner in a method that is very efficient in terms of time and costs, with the rolling characteristics of the tire being altered only slightly by the relatively small and thin surface modification.

The objects stated above are therefore achieved by the subject matter of the invention as defined in the claims. Preferred design embodiments according to the invention are derived from the dependent claims and from the explanations hereunder.

In particularly preferred embodiments, embodiments that are referred to as preferred hereunder are combined with features of other embodiments that are referred to as preferred. Combinations of two or more of the embodiments that are referred to as particularly preferred hereunder are thus most particularly preferred. Likewise preferred are embodiments in which a feature of one embodiment that is referred to as preferred to a certain extent is combined with one or more further features of other embodiments that are referred to as preferred to a certain extent. Features of preferred extrusion systems, methods and vulcanized rubber products will be apparent from the features of preferred extrusion templates.

The advantageous vulcanized rubber products of the present invention can be obtained by the method according to the invention. The method according to the invention relies in turn on the use of an extrusion system according to the invention, which is significantly influenced by an extrusion template according to the invention which enables the process management according to the invention and thus the obtaining of vulcanized rubber products according to the invention. The subjects of the present invention are therefore closely associated with one another. With a view to a comprehensible explanation of the present invention, it is expedient to start, as regards the disclosure of the invention, with the extrusion template according to the invention.

Accordingly, the invention relates in the first instance to an extrusion template for use in the extrusion of rubber products, comprising:
a) a template body,
b) a template cutout, which penetrates the template body along an extrusion direction E and which is delimited by encircling wall surfaces, and
c) an elongate injector element, which extends between the wall surfaces along the injector direction I through the template cutout, with an injection gap,
wherein the extrusion template is designed to produce a material gap in a material strand extruded through the template cutouts along the extrusion direction E by means of the injector element and to inject an injection composition into the material gap through the injection gap in order to bring the extruded material strand into contact with the injection composition at the walls of the material gap,
wherein the extrusion template comprises at least one distribution hollow in the wall surface of the template cutout, wherein the distribution hollow is wider than the injection gap along the transverse direction Q, which is perpendicular to the extrusion direction E and perpendicular to the injector direction I, and
wherein the extrusion template is designed such that an injection composition which is injected through the injection gap into the material gap can enter the distribution hollow, with the result that the extruded material strand which is guided via the distribution hollow can be brought into contact, on the outer side of the material strand that is guided along the wall surface, with the injection composition which is present in the distribution hollow.

The extrusion template according to the invention is suitable for use in the extrusion of rubber products. Extrusion templates are thoroughly well-known to a person skilled in the art in the sector of the rubber-processing industry. Extrusion templates are often subdivided by those skilled in the art into so-called preliminary and final templates, this expressing the position in the extrusion system where they are used. Preliminary templates generally guide the rubber strands used first of all into relatively close proximity, for which reason they generally comprise a plurality of cutouts, each of which serves to guide one rubber strand. In contrast to this, final templates generally have just one cutout, through which the individual rubber strands of the preliminary template are passed. The extrusion template according to the invention is suitable particularly for use as a final template since in this way it is possible to form a conductive web through the entire strand-shaped rubber product, on the surface of which an advantageous conductive region, via which the dissipation of electric charge can take place, is simultaneously formed. Accordingly, by way of example, there is an extrusion template according to the invention wherein the extrusion template is a preliminary template, wherein the extrusion template comprises two or more, preferably three or more, template cutouts that penetrate the template body along the extrusion direction E. However, there is a preference for an extrusion template according to the invention wherein the extrusion template is a final template, wherein the extrusion template preferably comprises precisely one template cutout.

Owing to the specific requirements made on treads of pneumatic vehicle tires, the extrusion templates according to the invention are suitable, in particular, for use in the production of these rubber products. There is thus a preference for an extrusion template according to the invention wherein the extrusion template is for use in the extrusion of treads for vehicle tires.

Like the extrusion templates known from the prior art, the extrusion template according to the invention first of all comprises a template body. This expression denotes the workpiece in which the various template cutouts of the extrusion template are arranged. By way of example, there is an extrusion template according to the invention wherein the template body is formed from metal, preferably from steel.

The template cutouts in the template body serve to guide the extruded material through the extrusion template. In the context of the present invention, the direction in which the material to be extruded is passed through the extrusion template is referred to here as the extrusion direction E. The shape of the template cutout correlates with the desired cross-sectional shape of the extruded material strand. In particular, trapezoidal cross sections have proven particularly suitable in this respect for the extrusion of treads. Accordingly, there is a preference for an extrusion template according to the invention wherein the template cutout has a polygonal cross section, preferably a quadrilateral cross section, particularly preferably a trapezoidal cross section, in the plane perpendicular to the extrusion direction E.

Since the template body will have a non-negligible thickness, a cutout that penetrates the template body will necessarily be delimited by encircling wall surfaces. In this respect, a circular template cutout would be delimited by just one encircling wall surface, for example, whereas a quadrilateral template cutout comprises four distinguishable individual wall surfaces as a surrounding wall. In this respect, there is a preference for an extrusion template according to the invention wherein the template cutout is delimited by four or more, preferably precisely four, wall surfaces.

In respect of above-described components a) and b), the extrusion template according to the invention corresponds in principle to the extrusion templates known from the prior art. However, the extrusion template according to the invention now also comprises an injector element with an injection gap, which extends between the wall surfaces of the template cutout, with the result that it passes through the template cutout. In the context of the present invention, the direction along which the injector element extends from one wall surface to the other is referred to as the injector direction I.

In extrusion templates according to the invention, the injector element has primarily two tasks. On the one hand, the injector element passing through the template cutout serves to split the material strand extruded through the template cutout by blocking part of the template cutout. As a result, a material gap is formed downstream of the injector element—which acts as a flow obstacle—in the extrusion direction. The injector element now serves to inject an injection composition into the material gap through an injection gap facing in the direction of this material gap. This enables the extruded material strand to be brought into contact with the injection composition at the walls exposed by the split. A person skilled in the art will understand that this is therefore an extrusion template according to the invention wherein the injector element is configured to be able to inject an injection composition through the injection gap.

For implementation of the desired injection function, it is expedient to connect the injector element to a supply of injection compositions via lines, for example. Accordingly, an extrusion template according to the invention which is relevant for most cases is one wherein the injector element is connected or can be connected fluidically to a fluid supply unit, wherein the fluid supply unit preferably comprises a pumping device and a reservoir for storing an injection composition.

In respect of the arrangement of the injector element, there is a particular preference, in the case of template cutouts with a polygonal cross section, for the injector element to extend between opposite parts of the wall. Thus, there is a preference for an extrusion template according to the invention wherein the injector element extends from one wall surface of the template cutout to an opposite wall surface.

A person skilled in the art will understand that the template cutout is divided into two parts by the injector element, wherein, in the estimation of the inventors, it is thus particularly advantageous in respect of the properties of the strand-shaped rubber products that can be produced thereby to position the injector element as centrally as possible, such that the conductive coating introduced through the injector element likewise extends as centrally as possible in the strand-shaped rubber product. There is a preference for an extrusion template according to the invention wherein the injector element is positioned in the template cutout in such a way that, in a plan view along the extrusion direction E, the template cutout is divided by the injector element into two partial areas, the areas of which differ by 50% or less, preferably by 30% or less, particularly preferably by 10% or less, particularly preferably by 5% or less.

In order to ensure that the material strand is split around the injector element in a manner which is as controlled as possible and that the extrusion templates according to the invention have a robust structure, the inventors deem it expedient to arrange the injector element as centrally as possible also with respect to the extrusion direction, thus ensuring that, upstream and downstream of the injector element in the extrusion direction, there is still some wall of the extrusion template remaining, by which the extruded material can be guided. Accordingly, there is a preference for an extrusion template according to the invention wherein the injector element is positioned in the template cutout in such a way that the injector element is at a distance from both outlet openings of the template cutout along the extrusion direction E which differs by 50% or less, preferably by 30% or less, particularly preferably by 10% or less, particularly preferably by 5% or less.

In principle, the desired splitting of the extruded material strand can be achieved with any shape of the obstacle which divides the template cutout into two or more regions, and therefore, for example, even injector elements of round cross section are suitable, which then have a cylinder-type shape. However, in the estimation of the inventors, it is particularly advantageous if controlled splitting of the material strand is promoted by providing a wedge shape or a similar taper, which promotes the division along the flanks of the wedge, something that, in particular, improves the flow behavior of the extruded material strand. Accordingly, by way of example, there is an extrusion template according to the invention wherein the injector element is of cylindrical design, at least in part, preferably over the entire length of that part of the injector element which extends in the template cutout. However, there is a preference for an extrusion template according to the invention wherein the injector element tapers, preferably in a drop shape, counter to the extrusion direction E on the side facing away from the injection gap.

At least in theory, it is possible to arrange the injector element obliquely relative to the extrusion direction in the extrusion template, with the result that the extruded material strand makes contact with the injector element earlier in one section and later in another section, relative to the extrusion direction. Even if such a configuration is conceivable, this is not associated with advantages which, in the estimation of the inventors, would justify the additional design effort. On the contrary, in the estimation of the inventors, good results can be achieved particularly if the injector element and thus the injection direction I are substantially orthogonal to the extrusion direction, with the result that the extruded material strand is split substantially orthogonally to the extrusion direction E by the injector element. There is thus a preference for an extrusion template according to the invention wherein the injector direction I encloses an angle with the extrusion direction E in the range of 70° to 110°, preferably an angle in the range of 80° to 100°, particularly preferably in the range of 85° to 95°, very particularly preferably of substantially 90°, and/or wherein the injector element and the wall surfaces in the region of contact encloses an angle in the range of 70° to 110°, preferably an angle in the range of 80° to 100°, particularly preferably in the range of 85° to 95°, very particularly preferably of substantially 90°.

Depending on the subsequent arrangement of the extrusion template and thus depending on the gravitational force acting during use, it is not necessary in principle to form the injection gap over the entire length of the injector element since it is possible, depending on the volume flow of the injection composition, that the injection composition emerging through a shorter injection gap will fill the material gap sufficiently to make contact with the extruded material strand at the walls over the entire height, this being particularly preferred. In view of this preferred embodiment, however, the inventors deem it to be particularly advantageous if the injection gap also extends substantially over the entire length over which coating is supposed to take place since a significantly more controlled and precise application of the injection composition to the material gap and to the walls thereof thereby becomes possible. Accordingly, there is a preference for an extrusion template according to the invention wherein the injection gap extends over the entire length of that part of the injector element which extends in the template cutout.

In the context of the present invention, the mode of operation is generally described with reference to the presence of precisely one injector element, wherein an extrusion template according to the invention which comprises precisely one injector element is accordingly suitable for the production of strand-shaped rubber products which comprise precisely one CCB. In this respect, however, the inventors propose that the extrusion templates according to the invention may also be designed in such a way that they can be used to form a plurality of thin CCBs in the extruded material. For certain applications, there is accordingly a preference for an extrusion template according to the invention wherein the extrusion template comprises two or more, preferably three or more injector elements, preferably of the same type.

A person skilled in the art will understand that, in the method according to the invention which is carried out with extrusion templates according to the invention, the division of the material strand and the subsequent bringing of the injection composition into contact with the walls of the material gap will be followed by renewed combination and re-joining of the previously separated parts of the material strand, by means of which the material gap will be closed. In the case of a preliminary template according to the invention, for example, this joining together can be performed by a downstream final template. Particularly in the case of final templates, however, it is also possible for the selected length of the template cutout in the extrusion direction E to be so great that the material gap can be joined together while still within the extrusion template according to the invention if the extruded material extends further along the walls of the template cutout downstream of the injection element in the extrusion direction. In this case, such a joining region of the template cutout can also comprise a section which has an at least slightly reduced total cross section relative to the template cutout at the level of the injector element, ensuring that the two split parts of the material strand are pressed against one another by a corresponding taper. In this case, there is a preference for an extrusion template according to the invention wherein the extrusion template comprises a joining region spaced apart from the injector element along the extrusion direction E, wherein the extrusion template is configured to close the material gap produced in the extruded material strand in the joining region by joining together the walls of the material gap which have been brought into contact with the injection composition, wherein the joining region is preferably formed by a joining section of the template cutout, in which the template cutout tapers along the extrusion direction E.

In this respect, the inventors propose suitable dimensions for typical template cutouts which are particularly suitable especially for the formation of tread components. Here, the dimensions of the template cutout in the extrusion template according to the invention can expediently be defined by way of the directions already defined. The extension along the extrusion direction E determines the depth of the template cutout. In the context of the present invention, the injector direction I, which is generally orthogonal to the extrusion direction E, is understood as the height of the template cutout. The transverse direction Q, which is orthogonal to the extrusion direction E and to the injector direction I, is also defined in the context of the present invention. In the particularly preferred case of a non-inclined arrangement of the injector element in the template cutout, the three directions E, I and Q thus correspond to the axes of a Cartesian coordinate system. There is a preference for an extrusion template according to the invention wherein the template cutout is an elongate template cutout and has a diameter in the range of 4 to 40 mm, preferably in the range of 5 to 30 mm, particularly preferably in the range of 6 to 10 mm, along the injector direction I. In addition or as an alternative, there is a preference for an extrusion template according to the invention wherein the template cutout is an elongate template cutout and has a diameter in the range of 5 to 500 mm, particularly preferably in the range of 6 to 450 mm, very particularly preferably in the range of 8 to 400 mm, along the transverse direction Q wherein the specific dimensions depend, in particular, on the products to be produced, and therefore extrusion templates for extruding truck treads will have larger dimensions than those for bicycle treads. In addition or as an alternative, there is a preference for an extrusion template according to the invention wherein the template cutout has a diameter in the range of 3 to 30 mm, particularly preferably in the range of 4 to 15 mm, very particularly preferably in the range of 5 to 8 mm, along the extrusion direction E.

Moreover, the inventors also propose expedient dimensions for the injector element and for the width of the injection gap, by means of which good results in the formation of the material gap and of uniform contacting of the corresponding walls can be achieved when processing typical vulcanizable rubber compounds and injecting a broad range of injection compositions. There is a preference for an extrusion template according to the invention wherein the injector element has a mean diameter in the range of 3 to 40 mm, particularly preferably in the range of 4 to 20 mm, very particularly preferably in the range of 6 to 10 mm, along the transverse direction Q. In addition or as an alternative, there is a preference for an extrusion template according to the invention wherein the injector gap has a mean diameter in the range of 0.1 to 2.0 mm, particularly preferably in the range of 0.2 to 1.0 mm, very particularly preferably in the range of 0.5 to 0.8 mm, along the transverse direction Q.

The particularly advantageous properties of extrusion templates according to the invention are obtained, in particular, through the use of one or more special cutouts in the wall surfaces of the template cutout, which are referred to in the context of the present invention as distribution hollows, because they serve to receive the injection composition injected into the material gap from the injector element and to enable the injection composition accumulated in the distribution hollow to make contact from the outside with the material strand forced out via this distribution hollow, with the result that the injection composition is as it were distributed.

Through the presence of these distribution hollows, the injection composition makes contact not only with the walls that are subsequently joined together again, but with part of the area which will subsequently form the surface of the extruded material strand, wherein the fluidic connection between the material gap and the distribution hollow ensures that, in the extruded material strand, the coated surface regions and the thin conductive web, which can be formed virtually simultaneously, are reliably connected to one another.

In this respect, a person skilled in the art will understand that the injector element will cast a flow shadow in the extrusion direction E, and therefore the material gap will have a certain volume. Accordingly, it would not be expedient to make the distribution hollow so small that it itself lies completely in the region of the material gap since, in this case, it could not be traversed by the split parts of the material strand. Consequently, the distribution hollow is also at least wider than the injection gap along the transverse direction Q. The actual width of the distribution hollow in the transverse direction will depend in subsequent practice principally on the properties of the vulcanizable rubber compound being processed, the extrusion rate and the geometrical configuration of the injector element acting as a flow obstacle since, in particular, these factors determine the dimensions of the material gap which forms. For the extrusion process desired by a person skilled in the art, the distribution hollow should accordingly have a larger area in the plane orthogonal to the injector direction I than the cross section of the material gap formed, wherein the actual dimensions are also determined by the intended width of the surface modification that the person skilled in the art wants to achieve by way of the distribution hollow.

For a specified extruder system with a specific vulcanizable rubber compound, it is an easy matter in light of the invention for a person skilled in the art to identify suitable dimensions of the distribution hollow and to optimize them in routine experiments, if required. The complex dependency of the configuration of the extrusion template according to the invention on the subsequent intended applications is taken into account in the context of the present invention by the fact that the extrusion template, as defined above, is configured to enable the injector composition injected into the material gap to penetrate into the distribution hollow in order to make contact there with the extruded material strand guided via the distribution hollow.

There is a fundamental preference for an extrusion template according to the invention wherein the distribution hollow is wider than the injection gap transversely to the extrusion direction E and transversely to the injector direction I by a factor of 2 or more, preferably by a factor of 5 or more, particularly preferably by a factor of 10 or more, very particularly preferably by a factor of 20 or more. In addition or as an alternative, there is also a preference for an extrusion template according to the invention wherein the distribution hollow is wider than the injector element transversely to the extrusion direction E and transversely to the injector direction I by a factor of 1.25 or more, preferably by a factor of 1.5 or more, particularly preferably by a factor of 2 or more, very particularly preferably by a factor of 5 or more. In addition or as an alternative, there is furthermore a preference for an extrusion template according to the invention wherein the distribution hollow preferably has a mean diameter in the range of 0.1 to 2 mm, particularly preferably in the range of 0.2 to 1.0 mm, very particularly preferably in the range of 0.3 to 0.7 mm, along the transverse direction Q.

The extrusion template according to the invention comprises at least one distribution hollow. A person skilled in the art will understand that a corresponding surface coating can thus be formed on one side of the injector element and hence on one side of the CCB produced in the material strand, as described above. In the estimation of the inventors, this is already sufficient for some applications, e.g. for ensuring good road contact for the CCB in the case of a tread. At the same time, however, the inventors deem it preferable for essentially all embodiments if two distribution hollows are provided in order to form a corresponding modification region on both sides on the surface of the extruded strand. Even if it is possible in theory to achieve the above-described functionality of an individual distribution opening by combining two separate distribution openings which extend, for example, to the left and to the right of the injector element, a person skilled in the art will have no difficulty in understanding that the two distribution hollows should preferably be arranged in the walls at opposite ends of the injector element, thus ensuring that a material strand extruded through the extrusion template is provided with an associated surface coating on both sides of the thin conductive web, thus making it possible, in the case of a tread, to ensure not only excellent road contact but also a reliable connection to underlying plies of the tread, for example. Accordingly, there is also a preference, in the case of essentially all the embodiments, for an extrusion template according to the invention wherein the extrusion template comprises at least one distribution hollow, preferably of the same type, in each of the opposite wall surfaces of the template cutout in the region of contact with the injector element, wherein the extrusion template is configured to enable an injection composition injected into the material gap through the injection gap to enter the distribution hollows, thus enabling the extruded material strand guided by the distribution hollows to be brought into contact with the injection composition present in the distribution hollows at the outer sides of the material strand which are guided along the wall surfaces.

Even if it is possible, by more sophisticated guidance of the fluid, to arrange the distribution hollows in such a way that these extend at least partially upstream of the injector element relative to the extrusion direction E, it is, in the estimation of the inventors, expedient for as reliable as possible contact between the CCB produced and the conductive surface coatings to provide the distribution hollows and the injection gap on the same side of the injector element. Accordingly, there is a preference for an extrusion template according to the invention wherein the distribution hollow is arranged in the wall surface of the template cutout on the side of the injector element which comprises the injection gap.

At least in theory, it is conceivable that the distribution hollow is spaced apart, by at least a certain amount, from the injector element along the extrusion direction E. However, in the estimation of the inventors, it is preferred in the case of essentially all the embodiments if the distribution hollow directly adjoins the injector element in the extrusion direction E, wherein, in particular, there is also a preference for embodiments in which part of the side wall of the distribution hollow is formed by parts of the injector element. There is a preference for an extrusion template according to the invention wherein the side wall of the distribution hollow is formed partially by the injector element.

During the design of extrusion templates according to the invention, it has been found that it is unproblematic if the distribution hollows exhibit a sharp edge at the end which is upstream in the extrusion direction since the extruded material compound usually slides across this without problems. Depending on the configuration of the materials used and on the dimensions of the distribution hollows, the material strand may, however, partially sink into the distribution hollow as it slides over the latter. If a very sharp edge is then also provided on the downstream side, as would be obtained, for example, with a fully square hollow, this edge of the distribution hollow may retard the part of the material strand that has sunk in and may lead to unwanted changes or impairments in the material and flow behavior. To avoid this, the inventors propose that that side of the distribution hollow which faces in the extrusion direction E should run out in a manner which is as flat as possible in order to guide any parts of the material strand which have sunk into the distribution hollow back onto the original extrusion path without too much resistance. Accordingly, there is a preference for an extrusion template according to the invention wherein the depth of the distribution hollow decreases along the extrusion direction E with increasing distance from the injector element. In addition or as an alternative, there is also a preference for an extrusion template according to the invention wherein the distribution hollow is flattened along the extrusion direction E away from the injector element. In addition or as an alternative, there is a preference here for an extrusion template according to the invention wherein the distribution hollow has a triangular or a trapezoidal cross section, preferably a triangular cross section, in a plane parallel to the extrusion direction E.

As a particularly preferred embodiment of extrusion templates according to the invention, the inventors propose that the injector element can be of exchangeable design. For this purpose, complementary openings or cutouts, into which an injector element can be inserted, can be provided on opposite sides of the wall. In this case, the injector insertion opening can be embodied, for example, as a drill hole through the template body, thus enabling the injector element to be passed through the drill hole into the template cutout until it is arranged in the injector receiving cutout on the opposite side and is fixed there, e.g. by form-locking engagement. It is thereby possible in an advantageous manner to match the choice of injector elements to the materials to be processed, e.g. in respect of the shape of the injector element and/or the configuration of the respective injection gap. Accordingly, there is a preference for an extrusion template according to the invention wherein the extrusion template comprises an injector receiving cutout and an injector insertion opening in the wall surfaces of the template cutout, wherein the injector element extends through the injector insertion opening into the injector receiving cutout, wherein the extrusion template is designed such that the injector element can be exchanged in a reversible and nondestructive manner, wherein the one or more distribution hollows are preferably formed by a part of the injector insertion opening and/or of the injector receiving cutout.

In a further development of the injector elements which can be exchanged in a reversible and nondestructive manner, the inventors propose that, in addition, a multiplicity of complementary insertion openings and receiving cutouts can be provided, thus enabling the extrusion template according to the invention to use the injector element in various injector positions in order, for example, to achieve higher flexibility in respect, for example, of the positioning of the CCB in the tread without having to manufacture a new extrusion template, thereby enabling the position of the CCB to be adapted to the desired profiling, for example. In such embodiments, it is expedient in the estimation of the inventors to close the unused injector insertion openings or injector receiving cutouts with suitable closure elements, e.g. with a form-fitting rubber plug. Consequently, there is a preference for an extrusion template according to the invention wherein the extrusion template comprises two or more, preferably three or more, particularly preferably four or more, complementary injector insertion openings and injector receiving cutouts for receiving an injector element in different injector positions, in the wall surfaces of the template cutout, wherein at least some of the injector positions, preferably all of the injector positions, are assigned at least one, preferably at least two opposite, distribution hollows, wherein, in one injector position, the injector element extends through the corresponding injector insertion opening into the corresponding injector receiving cutout, wherein the extrusion template is designed such that the position of the injector element can be changed in a reversible and nondestructive manner between the injector positions. There is a particular preference here for an extrusion template according to the invention wherein, in addition, the extrusion template comprises one or more closure elements for closing, preferably form-fittingly closing, injector insertion openings and injector receiving cutouts of injector positions not occupied by an injector element and/or distribution hollows assigned to these injector positions.

The invention also relates to an extrusion system comprising:
aa) at least one extruder, and
bb) at least one extrusion template according to the invention.

In this case, the extrusion template according to the invention can be combined essentially with all suitable typical extruders, which can be obtained commercially from various sources. Here, the positioning of the extrusion template according to the invention in the extrusion system will depend, in particular, on its embodiment as a preliminary template or a final template. By way of example, there is an extrusion system according to the invention wherein the extrusion system additionally comprises an additional preliminary template arranged between the extrusion template and the extruder or comprises an additional final template arranged on the side facing away from the extruder, wherein the additional preliminary template and the additional final template preferably do not comprise an injector element. As an alternative or in addition, another illustrative extrusion system according to the invention is one wherein the extrusion system additionally comprises a joining element which is arranged on the side facing away from the extruder and has a joining region, wherein the extrusion system is configured to close the material gap produced in the extruded material strand by joining together in the joining region the walls of the material gap which have been brought into contact with the injection composition, wherein the joining element is preferably formed by an additional final template arranged on the side facing away from the extruder.

The invention furthermore relates to a method for producing a strand-shaped vulcanizable rubber product, with an extrusion system according to the invention, comprising the following method steps:
i) extruding a material strand consisting of at least one vulcanizable rubber compound through the extrusion template according to the invention along the extrusion direction E by means of an extruder, wherein a material gap is produced in the material strand by the injector element,
ii) injecting an injection composition from the injection gap into the material gap and the distribution hollow in order to bring the material strand into contact with the injection composition at the walls of the material gap and on the outer side of the material strand that is guided along the wall surface in order to obtain a modified material strand,
iii) closing the material gap in the modified material strand by joining together the walls of the material gap that have been brought into contact with the injection composition in a joining region spaced apart from the injector element along the extrusion direction E.

The method according to the invention is used to produce strand-shaped vulcanizable rubber products, preferably tread components. However, the method according to the invention is not restricted to treads but is suitable fundamentally for adding to any thick-walled extrudate of a certain thickness, e.g. more than 2 mm, a conductive structure by means of which an electrostatic charge can be reliably dissipated. Accordingly, by way of example, there is a method according to the invention wherein the strand-shaped vulcanizable rubber product has a mean thickness of 2 mm or more perpendicularly to the extrusion direction E. There is a preference for a method according to the invention wherein the strand-shaped vulcanizable rubber product is a tread blank or a component ply of a tread blank.

It can be regarded as a major advantage of the method according to the invention that it is very flexible in respect of the vulcanizable rubber compound used. In light of the circumstances that the advantageous effects of the present invention are attributable essentially to design features of the extrusion template according to the invention and to the specific process management, it may advantageously be observed that the method according to the invention can be employed for essentially all typical vulcanizable rubber compounds, especially those which are used in treads of vehicle tires, and therefore reference may be made at this point especially to the prior art known to those skilled in the art. In this respect, by way of example, there is a method according to the invention wherein the vulcanizable rubber compound comprises one or more diene rubbers, and/or wherein the vulcanizable rubber compound comprises one or more fillers that are not electrically conductive, and/or wherein the vulcanizable rubber compound comprises one or more additives which are selected from the group comprising plasticizers, anti-ageing agents and coupling agents.

Because of the high relevance of the method according to the invention for providing extrudates of low conductivity with a conductive CCB, this will in most cases be a method according to the invention wherein the vulcanizable rubber compound comprises less than 10 phr, preferably less than 5 phr, particularly preferably less than 3 phr, in particular less than 0.1 phr, of carbon black.

In the light of the above statements, a person skilled in the art will understand that the extrusion templates according to the invention and the method according to the invention are in principle also not limited in respect of the injection composition used. A person skilled in the art will select a suitable injection composition essentially in light of their respective application requirements, the vulcanizable rubber compounds used, the extrusion materials, and the other parameters of their specific process management, thus ensuring that they are suitable for their purposes. In this context, examples of injection compositions that can be used are disclosed inter alia in the prior art acknowledged above. In this respect, by way of example, there is a method according to the invention wherein the injection composition is a dispersion, comprising:
at least one diene rubber, preferably polyisoprene,
at least one electrically conductive filler, preferably carbon black, preferably in a combined content by mass of 50 phr or more, preferably 70 phr or more, and
a carrier liquid, preferably in a combined content by mass of 450 phr or more, preferably 600 phr or more.

In this respect, in addition, by way of example, there is a method according to the invention wherein the injection composition additionally comprises:
at least one liquid diene polymer, preferably in a combined content by mass of 50 phr or more, preferably of 70 phr or more, and/or
a sulfur-based vulcanization system, preferably comprising at least one vulcanization accelerator, particularly preferably in a combined content by mass of 2.5 phr or more, preferably 5 phr or more.

The term phr (parts per hundred parts of rubber by weight) used here is the quantity indicator conventional in the rubber industry for compound formulations, by means of which the content by mass of the components in the rubber compound relative to the mass of the high-molecular-weight rubbers present in the rubber compound (weight-average molar mass Mw according to GPC greater than 60 000 g/mol) are indicated, wherein the combined content by mass of the high-molecular-weight rubbers in the rubber compound corresponds to 100 phr. Determination of the weight-average molar mass is effected by gel permeation chromatography according to DIN 55672-1:2016-03 (GPC with tetrahydrofuran as eluent, polystyrene standard; SEC=size exclusion chromatography).

For the selection of the injection composition, the inventors propose that, in the method according to the invention, particularly efficient processing is possible of injection compositions of which the viscosity is not too high, thus enabling them to flow in a particularly efficient way out of the material gap into the distribution hollow and there make contact with the walls. Accordingly, there is a preference for a method according to the invention wherein the injection composition at 20° C. has a dynamic viscosity n measured according to DIN 53211:1987-06 of 30 Pa*s or less, preferably of 20 Pa*s or less, particularly preferably of 10 Pa*s or less.

The injection compositions known from the prior art often rely on the use of a volatile solvent as a carrier liquid. It is thereby possible to apply the components of the rubber composition contained in the injection composition which are dispersed in the solvent to the walls of the material gap, where, after evaporation of the solvent, they remain as a coating. However, the inventors of the present invention have found that it is very much preferred both for process-engineering and health reasons, and with a view to the quality of the conductive webs obtained, to do without the use of volatile solvents as far as possible. Rather, the inventors have developed a technology in which the carrier liquid is formed by a high-boiling component, that is to say, in particular, a mineral oil and, in this case, especially a paraffinic mineral oil. The corresponding injection composition is not (at least not primarily) converted by evaporation of the solvent into a coating; instead a large proportion of the mineral oil can soak into the underlying vulcanizable rubber compound, leaving a coating which, owing to the contact with the injection composition, gives a superficial layer which, in particular, has an increased carbon black content and, as a result, an advantageous electrical conductivity. Accordingly, there is a particular preference for a method according to the invention wherein the carrier liquid is a mineral oil, preferably a paraffinic mineral oil. In addition or as an alternative, there is also a particular preference for a method according to the invention wherein the carrier liquid has a boiling point of 120° C. or more, preferably of 140° C. or more, particularly preferably of 160° C. or more.

The invention furthermore relates to a method for producing a vulcanized rubber product, comprising the method steps of the method according to the invention for producing a strand-shaped vulcanizable rubber product, as well as the following step:
iv) vulcanizing the strand-shaped vulcanizable rubber product or a rubber blank comprising the strand-shaped vulcanizable rubber product, preferably a vehicle tire blank, with the vulcanizable rubber compound being vulcanized, to obtain a vulcanized rubber product, preferably a vehicle tire.

Here, the strand-shaped vulcanizable rubber product is, for example, vulcanized by the method customary in the tire industry, e.g. by sulfur-based cross-linking, e.g. at a temperature in the range of 130 to 200° C., preferably in the range of 150 to 180° C.

Finally, the invention also relates to a vulcanized rubber product, preferably produced or capable of being produced by the method according to the invention for producing a vulcanized rubber product, with a rubber element comprising a vulcanized rubber compound,
wherein, on at least one surface, the rubber element comprises a modification region extending on the surface along a covering direction B,
wherein the rubber element comprises a modification layer connected to the modification region along the covering direction B and extending through the rubber element along a layer direction S,
wherein the modification region and the modification layer comprise a vulcanized rubber material, the composition of which differs from the composition of the vulcanized rubber compound,
wherein the mean width of the modification layer in the direction of extension A, which is perpendicular to the covering direction B and perpendicular to the layer direction S, is 30 μm or less,
wherein the mean width of the modification layer in the direction of extension A, which is perpendicular to the covering direction B and perpendicular to the layer direction S, is less than the mean width of the modification region.

In principle, the vulcanized rubber product can be any form of rubber product which comprises the extrusion of a strand-shaped starting material in a preceding work step. The vulcanized rubber product according to the invention is vulcanized and, accordingly, no longer comprises any vulcanizable rubber compounds but instead comprises the corresponding rubber materials that can be produced therefrom. Thus, the vulcanized rubber product comprises, in particular, a rubber element which comprises the specific conductive structure that can be produced by the method according to the invention. A corresponding rubber element can be the tread of a pneumatic vehicle tire, for example.

There is a preference for a vulcanized rubber product according to the invention wherein the vulcanized rubber product is a vehicle tire, preferably a pneumatic vehicle tire. In this context, there is a preference for a vulcanized rubber product according to the invention wherein the rubber element is a tread or a component ply of a tread, in particular a component ply of a tread which is intended for road contact.

In the context of the present invention, the assembly of the conductive structure from the web, i.e. the modification layer and the conductive surface layers, i.e. the modification regions, in the rubber element is defined above all with respect to two directions, namely the covering direction B and the layer direction S.

On at least one surface, the rubber element comprises a modification region, in which the composition differs from that of the rest of the vulcanized rubber compound in the rubber element, and, as explained above, this can be achieved by coating or modification of the previously vulcanizable rubber compound in the method according to the invention. A person skilled in the art will understand that the modification region is just that part which has been produced in the extruded strand-shaped vulcanizable rubber product by the action of the distribution hollows of extrusion templates according to the invention in the method according to the invention. Accordingly, the covering direction B corresponds, at the point in time of production of the as yet unvulcanized rubber element, to the extrusion direction E.

By virtue of the process management described above, the modification region is connected to a modification layer, i.e. the thin conductive CCB. This modification layer extends through the vulcanized rubber product and is connected materially to the superficial modification region. Owing to being brought into contact with the injection composition, the modification layer too has a chemical composition different from the surrounding vulcanized rubber compound.

The direction along which the modification layer extends through the rubber element is referred to as the layer direction S. Using as an example a tread of a pneumatic vehicle tire which comprises the conductive structure approximately centrally with respect to the tread, the covering direction B thus corresponds to the circumferential direction, while the layer direction S corresponds, for example, approximately to the radial direction.

The above definition of vulcanized rubber products according to the invention furthermore expresses what dimensions the modification layer and the modification region have relative to one another. These relations would be defined, in the direction perpendicular to the covering direction B and perpendicular to the layer direction S, as the direction of extension A. In a preferred embodiment of a substantially orthogonal orientation of the modification layer and the modification region, this third direction corresponds to the third axis of a Cartesian coordinate system. Using as an example a tread located on a vehicle tire, the covering direction of which is the circumferential direction and the layer direction of which is the radial direction, the direction of extension A would correspond to the axial direction.

Preferred vulcanized rubber products according to the invention will be apparent from the above statements relating to preferred methods and extrusion templates.

There is a preference, for example, for a vulcanized rubber product according to the invention wherein, on each of two opposite surfaces, preferably on the surfaces provided for road contact and the surface facing away from said surfaces, the rubber element comprises a modification region extending on the surface along a covering direction B, wherein the modification layer is connected to both modification regions.

There is furthermore a preference for a vulcanized rubber product according to the invention wherein the modification layer extends completely through the rubber element along the layer direction S.

There is also a preference for a vulcanized rubber product according to the invention wherein the rubber element comprises two or more tread plies consisting of different vulcanized rubber compounds, wherein the modification layer extends through all the tread plies along the layer direction S.

There is likewise a preference for a vulcanized rubber product according to the invention wherein the rubber element is arranged in the vulcanized rubber product with one surface on an electrically conductive ply, wherein the modification layer extends along the layer direction S from the surfaces provided for road contact to the electrically conductive ply, wherein the modification region is preferably brought into contact with the electrically conductive ply.

There is likewise a preference for a vulcanized rubber product according to the invention wherein the mean width of the modification layer in the direction of extension A is 20 μm or less, preferably 10 μm or less, particularly preferably 5 μm or less, and/or wherein the mean width of the modification layer in the direction of extension A is in the range of 0.5 to 20 μm, preferably in the range of 1 to 10 μm.

There is furthermore a preference for a vulcanized rubber product according to the invention wherein the mean width of the modification region in the direction of extension A is 50 mm or less, preferably 10 mm or less, particularly preferably 5 mm or less, and/or wherein the mean width of the modification region in the direction of extension A is in the range of 1 to 40 mm, preferably in the range of 2 to 20 mm, particularly preferably in the range of 3 to 10 mm.

In addition, there is a preference for a vulcanized rubber product according to the invention wherein the mean width of the modification layer in the direction of extension A is wider than the modification layer by a factor of 20 or more, preferably by a factor of 50 or more, particularly preferably by a factor of 100 or more, very particularly preferably by a factor of 200 or more.

There is also a preference for a vulcanized rubber product according to the invention wherein the vulcanized rubber material has a higher electrical conductivity than the vulcanized rubber compound, preferably by a factor of 10 or more, preferably by a factor of 100 or more, particularly preferably by a factor of 1000 or more.

Moreover, there is a preference for a vulcanized rubber product according to the invention wherein the vulcanized rubber compound can be produced by vulcanizing a vulcanizable rubber compound, and wherein the vulcanized rubber material can be produced by vulcanizing an injection composition, comprising:
at least one diene rubber, preferably polyisoprene,
at least one electrically conductive filler, preferably carbon black, preferably in a combined content by mass of 50 phr or more, preferably 70 phr or more, and
a carrier liquid, preferably in a combined content by mass of 450 phr or more, preferably 600 phr or more.
   or a mixed composition comprising the vulcanizable rubber compound and the injection composition, which can be produced by bringing the injection composition into contact with the vulcanizable rubber compound.

### BRIEF DESCRIPTION OF THE SEVERAL VIEW OF THE DRAWINGS

The invention and preferred embodiments of the invention will be explained and described in more detail hereunder with reference to the appended figures. In the figures:

FIG. 1 shows a greatly simplified schematic illustration of material defects that occur in the prior art;

FIG. 2 shows a schematic illustration of an extrusion template according to the invention in a preferred embodiment;

FIG. 3 shows an enlarged illustration of the region around the injector element of the extrusion template according to the invention shown in FIG. 2;

FIG. 4 shows a schematic exploded illustration of a vulcanized rubber product according to the invention in a preferred embodiment; and

FIG. 5 shows a schematic visualization of the conductive structure of the vulcanized rubber product shown in FIG. 4.

### DETAILED DESCRIPTION

FIG. 1 visualizes, in a greatly simplified illustration, what defects may occur in extruded material strands when the conductive web is made particularly thin. In FIG. 1a), the conductive web is overlapped after extrusion by the material strands that flank it and does not extend as far as that surface of the corresponding rubber product which is intended for contact. In FIG. 1b), the end of the conductive web is covered by a material displacement of the kind that may occur after a tread blank has been inserted into the tire mold, for example. In neither of the cases in FIG. 1 can the conductive web ensure the required dissipation of an electric charge.

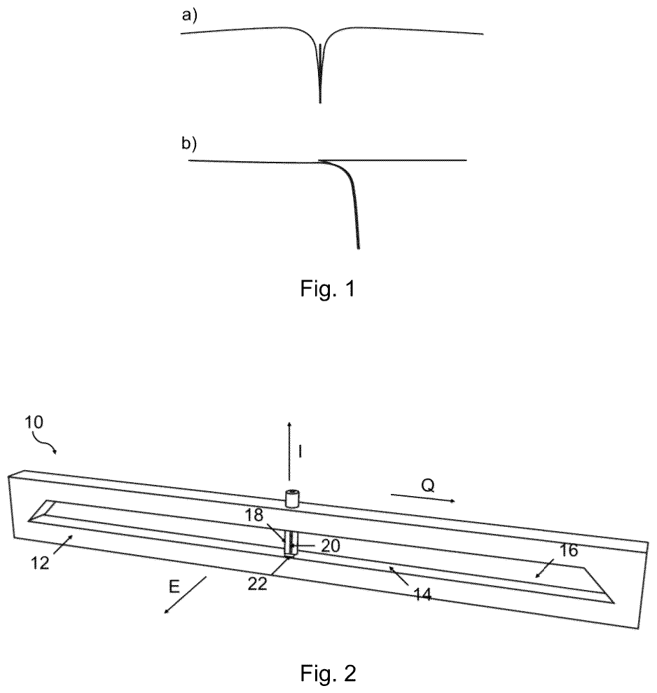

FIG. 2 shows an extrusion template 10 according to the invention, sometimes also referred to as an injection bar, in a preferred embodiment. In this case, the extrusion direction E, the injector direction I and the transverse direction Q have been entered in FIG. 2.

The extrusion template 10 according to the invention comprises a template body 12 and, in this template body 12, a template cutout 16 surrounded by wall surfaces 14. An injector element 18 extends through the template cutout 16, between the wall surfaces 14, and comprises an injection gap 20.

In the example shown in FIG. 2, the extrusion template 10 is embodied as a preliminary template and has a template body 12 made of steel, in which there is a template cutout 16 of trapezoidal cross section. The injector element 18 extends between the wall surfaces 14 through the template cutout 16 and, in the example shown, is arranged precisely centrally.

At the end of the injector element 18 which lies outside the extrusion template 10, a drill hole is indicated, via which the injector element 18 can be connected via fluid lines to a reservoir for the injection composition (not shown). In this case, the cylindrical injector element 18 is substantially orthogonal to the wall surfaces 14, wherein the injection gap 20 extends substantially over the entire height of the template cutout 16. In the wall surfaces 14 of the template cutout 16, in each case in the region of contact with the injector element 18, the extrusion template 10 has two distribution hollows 22 of identical design (only one is visible), which are provided to enable the injection composition from the injection gap 20 also to enter the distribution hollow 22 during operation, thus enabling the injection composition to be brought into contact also with an extruded material strand passed therethrough from the outer side running along the walls.

The injector element 18 in FIG. 2 is designed as an injector element 18 which can be exchanged in a reversible and nondestructive manner and can be removed along the injector direction I. An injector element 18 provided for exchange can then be passed through the injector insertion opening thus formed, through the template body 12, until it engages in a complementary injector receiving cutout in the opposite wall surface 14, wherein, in the example shown, part of the wall of the distribution hollows 22 is only formed by the insertion of the injector element 18 into the injector receiving cutout. In other words, the injector receiving cutout and the injector insertion opening in the embodiment illustrated are each connected to the respective distribution hollows 22 in such a way that the latter obtain their final dimensions only when an injector element 18 has been inserted.

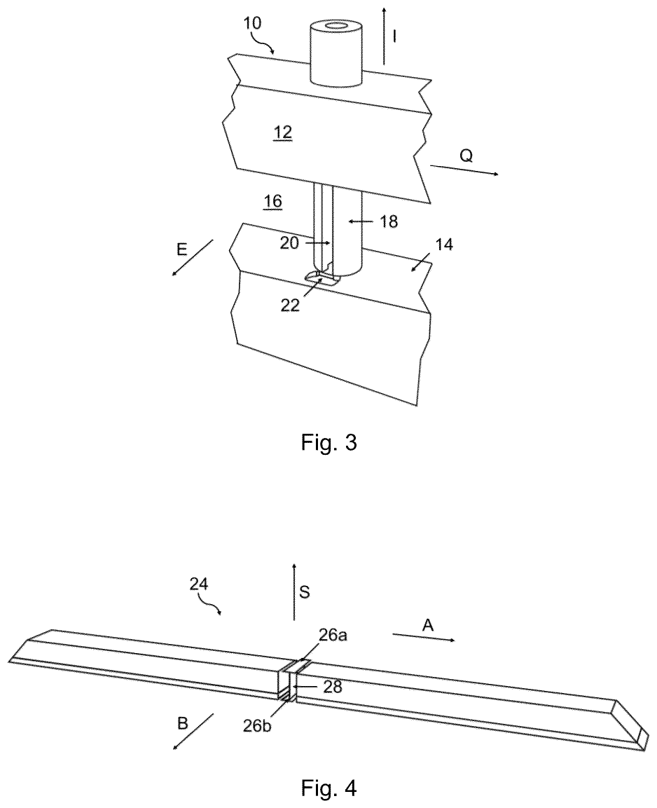

FIG. 3 shows an enlarged detail of the extrusion template 10 according to the invention shown in FIG. 2, wherein, in particular, the details in the region of the injector element 18 are illustrated on an enlarged scale. One of the two distribution hollows 22 is particularly clearly visible in FIG. 3. In the transverse direction Q, the distribution hollow 22 is wider than the injection gap 20, wherein those relationships which are particularly relevant in practice are not shown in the schematic illustration in FIG. 3. In practice, the injection gap 20 will in most cases probably be significantly smaller than is indicated in FIG. 3 for reasons of clarity. For example, the injection gap 20 can have a mean width of about 0.1 mm, whereas the distribution hollow 22 has a width of, for example, 3 mm in the transverse direction Q in order to form advantageously wide contact surfaces in the rubber product that can be produced therewith. It can be seen in FIG. 3 that the distribution hollows 22 taper along the extrusion direction E, thus giving a flattened distribution hollow 22, the depth of which decreases with increasing distance from the injector element 18 in order to exert as little influence on the flow of the extruded material strand as possible.

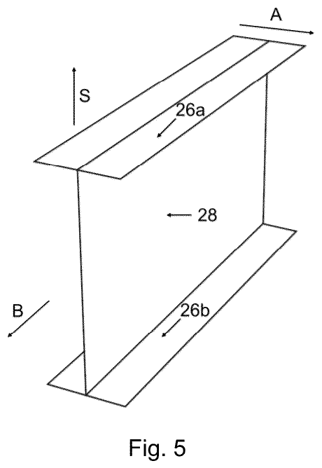

FIG. 4 then shows a schematic illustration, in an exploded view, of a vulcanized rubber product 24 of the kind that could be obtained with an extrusion template 10 shown in FIGS. 2 and 3, wherein, for the sake of clarity, only one segment of a strand is depicted, and this may also extend over a significantly longer length in the covering direction B. The schematically illustrated vulcanized rubber product 24 is a tread with a “cap” and “base” construction.

The tread parts consisting of vulcanized rubber compound, which are arranged on both sides, are separated from one another by an electrically conductive structure which can be produced by the method according to the invention, using an extrusion template 10 according to the invention, wherein the selected exploded view serves to make this structure more visible. FIG. 4 shows a detail of a tread, wherein the covering direction B, along which the modification region 26a, 26b extends on the surface of the vulcanized rubber product 24, has been entered. Also entered is the layer direction S, along which the modification layer 28 extends through the “cap” and “base” ply of the vulcanized rubber product 24. The direction of extension A, along which the width of the modification layer 28 and of the two modification regions 26a, 26b can be determined, is in each case perpendicular to these two directions. With the modification layer 28, the vulcanized rubber product 24 comprises an advantageously thin CCB, for which, however, in contrast to the prior art, advantageous contacting is made possible by the large but, on the other hand, thin modification regions 26a, 26b.

Finally, FIG. 5 shows a schematic enlarged illustration of the conductive structure in FIG. 4. In this, it can clearly be seen that the two modification regions 26a, 26b have a significantly greater mean width along the direction of extension A than the modification layer 28. At the same time, however, it can also be seen that the thickness of the modification regions 26a, 26b along the layer direction does not differ to any great extent from the thickness of the modification layer 28.

### LIST OF REFERENCE SIGNS

10 extrusion template
12 template body
14 wall surfaces
16 template cutout
18 injector element
20 injection gap
22 distribution hollow
24 vulcanized rubber product
26a,b modification region
28 modification layer
E extrusion direction
I injector direction
Q transverse direction
B covering direction
S layer direction
A direction of extension

1. An extrusion template for use in the extrusion of rubber products, comprising:
a) a template body,
b) a template cutout, which penetrates the template body along an extrusion direction E and which is delimited by encircling wall surfaces, and
c) an elongate injector element, which extends between the wall surfaces along the injector direction I through the template cutout, with an injection gap, wherein the extrusion template is designed to produce a material gap in a material strand extruded through the template cutouts along the extrusion direction E by means of the injector element and to inject an injection composition into the material gap through the injection gap in order to bring the extruded material strand into contact with the injection composition at the walls of the material gap,
wherein the extrusion template comprises at least one distribution hollow in the wall surface of the template cutout, wherein the distribution hollow is wider than the injection gap along the transverse direction Q which is perpendicular to the extrusion direction E and perpendicular to the injector direction I, and
wherein the extrusion template is designed such that an injection composition which is injected through the injection gap into the material gap can enter the distribution hollow, with the result that the extruded material strand which is guided via the distribution hollow can be brought into contact, on the outer side of the material strand that is guided along the wall surface, with the injection composition which is present in the distribution hollow.

2. The extrusion template as claimed in claim 1, wherein the distribution hollow is wider than the injection gap transversely to the extrusion direction E and transversely to the injector direction I by a factor of 5 or more.

3. The extrusion template as claimed in claim 1, wherein the depth of the distribution hollow decreases along the extrusion direction E with increasing distance from the injector element.

4. The extrusion template as claimed in claim 1, wherein the side wall of the distribution hollow is formed partially by the injector element.

5. The extrusion template as claimed in claim 1, wherein the extrusion template comprises at least one distribution hollow in the region of contact with the injector element in each of the opposite wall surfaces of the template cutout.

6. The extrusion template as claimed in claim 1, wherein the extrusion template comprises an injector receiving cutout and an injector insertion opening in the wall surfaces of the template cutout, wherein the injector element extends through the injector insertion opening into the injector receiving cutout, wherein the extrusion template, wherein the injector element can be exchanged in a reversible and nondestructive manner.

7. The extrusion template as claimed in claim 1, wherein the extrusion template comprises two or more complementary injector insertion openings, and injector receiving cutouts for receiving an injector element in different injector positions, in the wall surfaces of the template cutout, wherein at least some of the injector positions are assigned at least one distribution hollow, wherein, in one injector position, the injector element extends through the corresponding injector insertion opening into the corresponding injector receiving cutout, wherein the position of the injector element can be changed in a reversible and nondestructive manner between the injector positions.

8. The template of claim 1, further comprising:
at least one extruder, and
wherein the template and the at least one extruder are of an extrusion system.

9. A method for producing a strand-shaped vulcanizable rubber product, with an extrusion system, comprising:
i) extruding a material strand consisting of at least one vulcanizable rubber compound through the extrusion template along the extrusion direction E by an extruder, wherein a material gap is produced in the material strand by the injector element,
ii) injecting an injection composition from the injection gap into the material gap and the distribution hollow in order to bring the material strand into contact with the injection composition at the walls of the material gap and on the outer side of the material strand that is guided along the wall surface in order to obtain a modified material strand,
iii) closing the material gap in the modified material strand by joining together the walls of the material gap that have been brought into contact with the injection composition in a joining region spaced apart from the injector element along the extrusion direction E.

10. The method as claimed in claim 9, wherein the strand-shaped vulcanizable rubber product is a tread blank.

11. The method of claim 9, further comprising:
iv) vulcanizing the strand-shaped vulcanizable rubber product comprising the strand-shaped vulcanizable rubber product, with the vulcanizable rubber compound being vulcanized, to obtain a vulcanized rubber product.

12. The method of claim 11, wherein the vulcanized rubber product, having a rubber element, comprising a vulcanized rubber compound, wherein, on at least one surface, the rubber element comprises a modification region extending on the surface along a covering direction B,
wherein the rubber element comprises a modification layer connected to the modification region along the covering direction B and extending through the rubber element along a layer direction S,
wherein the modification region and the modification layer comprise a vulcanized rubber material, the composition of which differs from the composition of the vulcanized rubber compound,
wherein the mean width of the modification layer in the direction of extension A, which is perpendicular to the covering direction B and perpendicular to the layer direction S, is 30 μm or less,
wherein the mean width of the modification layer in the direction of extension A, which is perpendicular to the covering direction B and perpendicular to the layer direction S, is less than the mean width of the modification region.

13. The method of claim 12, wherein the vulcanized rubber product, has on each of two opposite surfaces provided for road contact and the surface facing away from said surfaces, the rubber element comprises a modification region extending on the surface along a covering direction B, wherein the modification layer is connected to both modification regions.

14. An extrusion system comprising:
an extrusion template comprising:
a template body,
a template cutout, which penetrates the template body along an extrusion direction E and which is delimited by encircling wall surfaces;
an elongate injector element, which extends between the wall surfaces along an injector direction I through a template cutout with an injection gap;
wherein the extrusion template is designed to produce a material gap in a material strand extruded through the template cutouts along the extrusion direction E by the injector element and to inject an injection composition into the material gap through the injection gap to bring the extruded material strand into contact with the injection composition at the walls of the material gap;
wherein the extrusion template comprises at least one distribution hollow in the wall surface of the template cutout, wherein the distribution hollow is wider than the injection gap along the transverse direction Q which is perpendicular to the extrusion direction E and perpendicular to the injector direction I; and
wherein the extrusion template is designed such that an injection composition which is injected through the injection gap into the material gap can enter the distribution hollow, with the result that the extruded material strand which is guided via the distribution hollow can be brought into contact, on the outer side of the material strand that is guided along the wall surface, with the injection composition which is present in the distribution hollow; and
an extruder to inject a rubber product material as the injection composition through the injection gap of the extrusion template to form a material strand in a tread of a tire, the material strand as a carbon center beam (CCB) and providing an electrically conductive connection between a surface of the tread and a base ply.

15. The system of claim 14, the material strand having an I shape.

16. The system of claim 14, wherein the distribution hollow is wider than the injection gap transversely to the extrusion direction E and transversely to the injector direction I by a factor of 5 or more.

17. The system of claim 16, wherein the depth of the distribution hollow decreases along the extrusion direction E with increasing distance from the injector element.

18. The system of claim 17, wherein the side wall of the distribution hollow is formed partially by the injector element.

19. The system of claim 18, wherein the extrusion template comprises at least one distribution hollow in the region of contact with the injector element in each of the opposite wall surfaces of the template cutout.

20. The extrusion template of claim 19, wherein the extrusion template comprises an injector receiving cutout and an injector insertion opening in the wall surfaces of the template cutout, wherein the injector element extends through the injector insertion opening into the injector receiving cutout, wherein the extrusion template, wherein the injector element can be exchanged in a reversible and nondestructive manner.
